(19) United States
(12) Patent Application Publication
(10) Pub. No.: US 2016/0339810 A1
(43) Pub. Date: Nov. 24, 2016

(54) VEHICLE SEAT

(71) Applicant: JOHNSON CONTROLS COMPONENTS GMBH & CO. KG, Kaiserslautern (DE)

(72) Inventors: Wolfgang PLUTA, Heiligenmoschel (DE); Heinrich HAMMANN, Teschenmoschel (DE); Thomas DILL, Heiligenmoschel (DE); Christian WOLF, Katzenbach (DE)

(21) Appl. No.: 15/110,529

(22) PCT Filed: Jan. 6, 2015
(86) PCT No.: PCT/EP2015/050098

§ 371 Date: Jul. 8, 2016

(30) Foreign Application Priority Data
Jan. 10, 2014 (DE) 10 2014 200 322.9
Mar. 12, 2014 (DE) 10 2014 204 558.4

(51) Int. Cl. B60N 2/22; B60N 2/20; B60N 2/235; B60N 2/01

(52) U.S. Cl. CPC B60N 2/2227; B60N 2/01; B60N 2/20; B60N 2/2222; B60N 2/2362

(57) ABSTRACT

A vehicle seat (1) has a seat segment (14) including a first seating location (11) having a first backrest (21), a second seating location (12) having a second backrest (22), and a seat part (24). The first backrest (21) and the second backrest (22) are connected to the seat part (24) and can be pivoted about a pivot axis (A) in relation to the seat part (24). A first fitting (61) has a first fitting part which is connected to the seat part (24) in a rotationally fixed manner and a second fitting part which is connected to the first backrest (21) in a rotationally fixed manner. A second fitting (62) has a first fitting part which is connected to the first backrest (21) in a rotationally fixed manner and a second fitting part which is connected to the second backrest (22) in a rotationally fixed manner.

### CROSS REFERENCE TO RELATED APPLICATIONS

This application is a United States National Phase Application of International Application PCT/EP2015/050098 filed Jan. 6, 2015 and claims the benefit of priority under 35 U.S.C. §119 of German Applications 10 2014 200 322.9 filed Jan. 10, 2014 and 10 2014 204 558.4 filed Mar. 12, 2014, the entire contents of which are incorporated herein by reference.

### FIELD OF THE INVENTION

The invention relates to a vehicle seat having a seat segment, which comprises a first seating position having a first backrest and a second seating position having a second backrest and a seat member, wherein the first backrest and the second backrest are connected to the seat member and can be pivoted relative to the seat member about a pivot axis, and wherein there is provided a first fitting whose first fitting member is connected to the seat member in a rotationally secure manner and whose second fitting member is connected to the first backrest in a rotationally secure manner.

### BACKGROUND OF THE INVENTION

DE 10 2007 011 874 A1 discloses a vehicle seat of the generic type. The vehicle seat which is constructed as a rear seat comprises two seat segments, wherein one of the seat segments comprises one seating position and the other seat segment comprises two seating positions. The two seat segments are arranged beside each other and can be displaced independently of each other by means of longitudinal adjusters in the travel direction. A first backrest and a second backrest which can be pivoted about the same pivot axis are fitted beside each other to the seat segment which comprises two seating positions. A pivotable third backrest is fitted to the seat segment which comprises one seating position. Each of the three backrests is pivotably fitted to a seat member of the respective seat segment by means of two fittings. The fittings are constructed as catch fittings. By unlocking the two fittings which are associated in each case with a backrest, the respective backrest can be pivoted about the pivot axis A relative to the seat member.

There are also known vehicle seats which comprise a curved locking member which is arranged on a first backrest and a locking device which is arranged on a second backrest. When the locking unit is locked to the curved locking member, the two backrests are coupled to each other.

DE 10 2013 003 790 B3 discloses a generic vehicle seat having a free running action and having a seat segment which comprises a first seating position with a first backrest and a second seating position with a second backrest and a seat member, wherein the first backrest and the second backrest are connected to the seat member and can be pivoted relative to the seat member about a pivot axis, and wherein there is provided a first fitting whose first fitting member is connected to the seat member in a rotationally secure manner, and whose second fitting member is connected to a connection pipe of the first backrest in a rotationally secure manner. The vehicle seat additionally has a second fitting whose first fitting member is connected to the seat member and whose second fitting member is connected to a connection pipe of the second backrest.

EP 2 067 419 A1 discloses a vehicle seat having a seat segment which comprises a first seating position having a first backrest and a second seating position having a second backrest and a seat member, wherein the first backrest and the second backrest are connected to the seat member and can be pivoted relative to the seat member about a pivot axis, and wherein there is provided a first fitting whose first fitting member is connected to an adapter of the seat member in a rotationally secure manner and whose second fitting member is connected to an adapter of the first backrest in a rotationally secure manner. The vehicle seat further has a second fitting whose first fitting member is connected to an adapter of the seat member and whose second fitting member is connected to an adapter of the second backrest.

### SUMMARY OF THE INVENTION

An object of the invention is to improve a vehicle seat of the type mentioned in the introduction, in particular with simplified construction to achieve a connection of the first backrest to the second backrest where necessary. In particular, the first backrest is intended to be connected to the second backrest by means of a mechanism which is arranged in the region of the pivot axis.

This object is achieved according to the invention by a vehicle seat having a seat segment which comprises a first seating position having a first backrest and a second seating position having a second backrest and a seat member, wherein the first backrest and the second backrest are connected to the seat member and can be pivoted relative to the seat member about a pivot axis, and wherein there is provided a first fitting whose first fitting member is connected to the seat member in a rotationally secure manner and whose second fitting member is connected to the first backrest in a rotationally secure manner, and wherein there is provided a second fitting whose first fitting member is connected to the first backrest in a rotationally secure manner and whose second fitting member is connected to the second backrest in a rotationally secure manner.

As a result of the fact that there is provided a second fitting whose first fitting member is connected to the first backrest in a rotationally secure manner and whose second fitting member is connected to the second backrest in a rotationally secure manner, no locking device and no curved locking member are required in the upper region between the backrests. When the second backrest is in the non-use position, there is consequently no curved locking member protruding in a visible manner.

As a result of the construction of the vehicle seat according to the invention without a protruding curved locking member, legal provisions with respect to protruding components can be complied with in a simpler manner.

By folding the second backrest into the non-use position, transport of long, narrow objects, for example, skis, is possible. As a result of the construction of the vehicle seat according to the invention, damage to the skis by a protruding curved locking member is prevented.

As a result of the construction of the vehicle seat according to the invention without a locking device, an additional lining of a locking device and openings in which dirt can accumulate are prevented.

Advantageous embodiments which can be used individually or in combination with each other are set out in the dependent claims.

Advantageously, the vehicle seat comprises an unlocking unit by means of which the second fitting can be unlocked independently of the first fitting. Consequently, the second backrest can be pivoted about the pivot axis independently of the first backrest.

The second backrest is preferably additionally connected to the seat member by means of a simple rotary bearing which is lighter and more cost-effective than an additional fitting. Another fitting is not required; forces and torques which occur, in particular crash loads, are absorbed by the second fitting.

In order to support the first backrest, there is preferably additionally provided an adjustment fitting whose first fitting member is connected to the seat member in a rotationally secure manner and whose second fitting member is connected to the first backrest in a rotationally secure manner. The first backrest is consequently connected to the seat member by means of two fittings.

In this instance, there is advantageously provided an actuation unit by means of which the adjustment fitting can be unlocked at the same time as the first fitting. By unlocking both fittings, the first backrest can be pivoted about the pivot axis.

According to an advantageous embodiment of the invention, there is, when pivoting the second backrest from a position for use into a non-use position, a free running action with respect to the first backrest. When the second fitting is unlocked and the first fitting is locked, the second backrest can be pivoted into the non-use position whilst the first backrest remains in the position for use.

According to another advantageous embodiment of the invention, there is, when pivoting the second backrest from a non-use position into a position for use, an entrainment connection with respect to the first backrest. When the second fitting is unlocked and the first fitting is locked, the second backrest cannot be pivoted into the position for use as long as the first backrest remains in the non-use position. When the second fitting is unlocked and the first fitting is unlocked, the second backrest can be pivoted about the pivot axis into the position for use and in this instance carries the first backrest from the non-use position into the position for use.

Consequently, the second backrest is prevented from assuming a position for use whilst the first backrest remains in the non-use position. This is required in particular when a safety belt which is associated with the second backrest is spatially integrated in the first backrest.

A compact construction is achieved when the first fitting member of the first fitting is securely connected to a first lower fitting member which is spatially arranged between the first fitting and the second fitting. The first lower fitting member is in this instance connected to the seat member.

A compact construction is also achieved when the first fitting member of the second fitting is securely connected to a second lower fitting member which is arranged spatially between the first fitting and the second fitting. The second lower fitting member may partially engage around the first lower fitting member radially at the outer side so that a connection between the second lower fitting member and a first upper fitting member is possible in a simple manner. The first upper fitting member is preferably secured to the first backrest. The second fitting member of the first fitting is preferably securely connected to the first upper fitting member which is securely connected to the second lower fitting member.

The first fitting and the second fitting are preferably an integral component of a fitting unit which can be constructed as a verifiable unit and in a modular manner. The fitting unit is preferably arranged between the first backrest and the second backrest. Preferably, the fitting unit is arranged in a lower region of the backrests close to the pivot axis. The center of gravity of the vehicle seat is thereby displaced downward.

The first fitting and the second fitting may each form a disc-like unit in a structural regard. The two fitting members of each fitting are each held together by means of a clamping ring. Such fittings require a particularly small amount of structural space in the vehicle seat, in particular in the transverse direction.

As a result of an advantageous configuration of the fitting unit, both backrests can be adjusted independently of each other into a position for use within a predeterminable comfort region.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of an embodiment of a vehicle seat without upholstery, wherein all the backrests are located in the position for use;

FIG. 2 is a detailed view of the first seat segment from FIG. 1;

FIG. 3 is an exploded view of a fitting unit;

FIG. 4 is a perspective view of the vehicle seat from FIG. 1, wherein the second backrest is located in the non-use position; and

FIG. 5 is a perspective view of the vehicle seat from FIG. 1, wherein the first backrest and the second backrest are located in the non-use position.

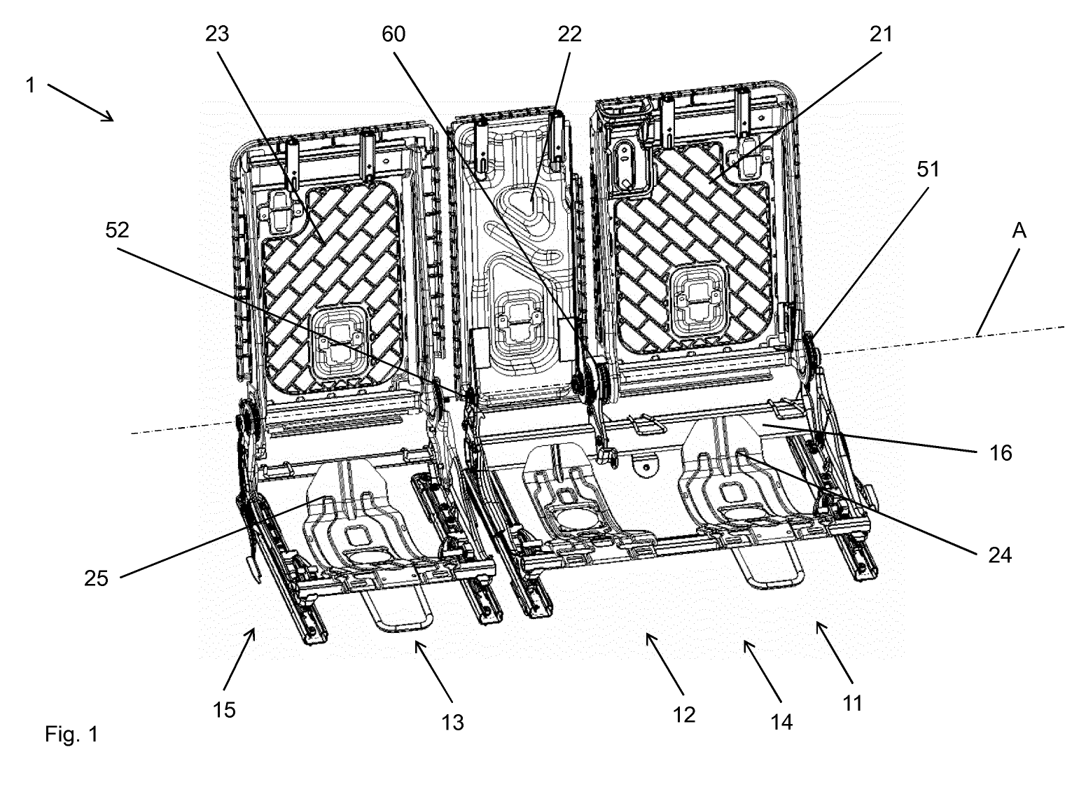

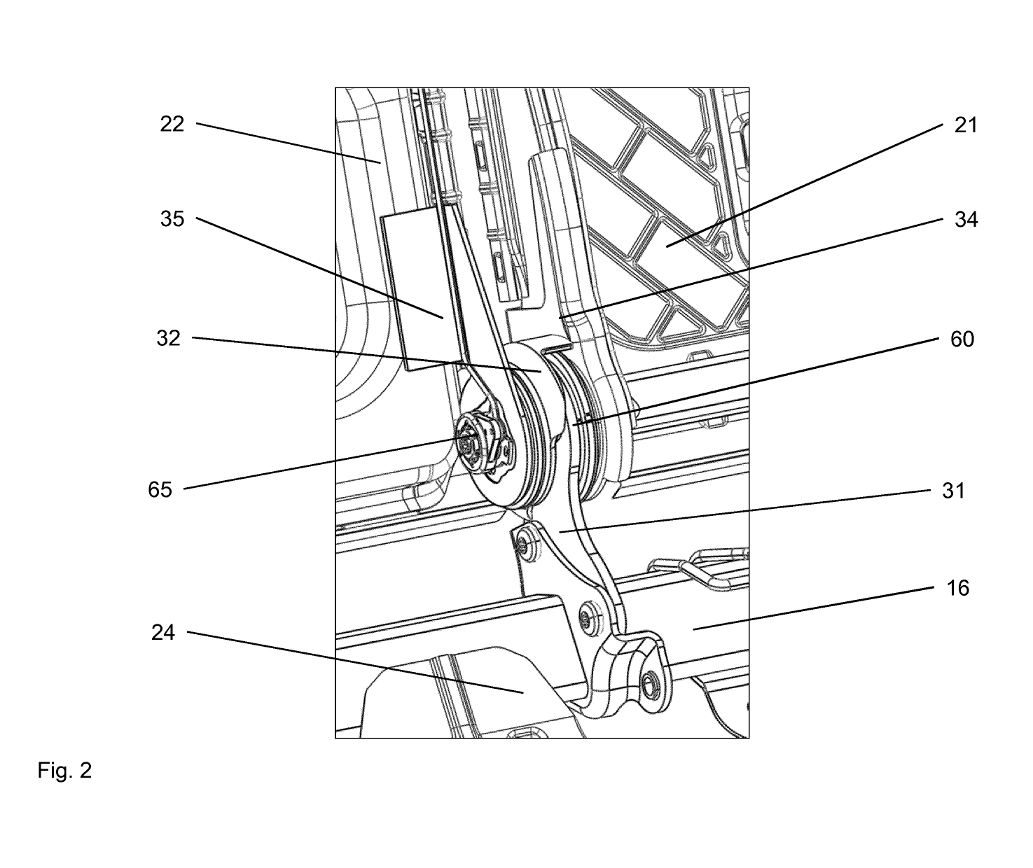

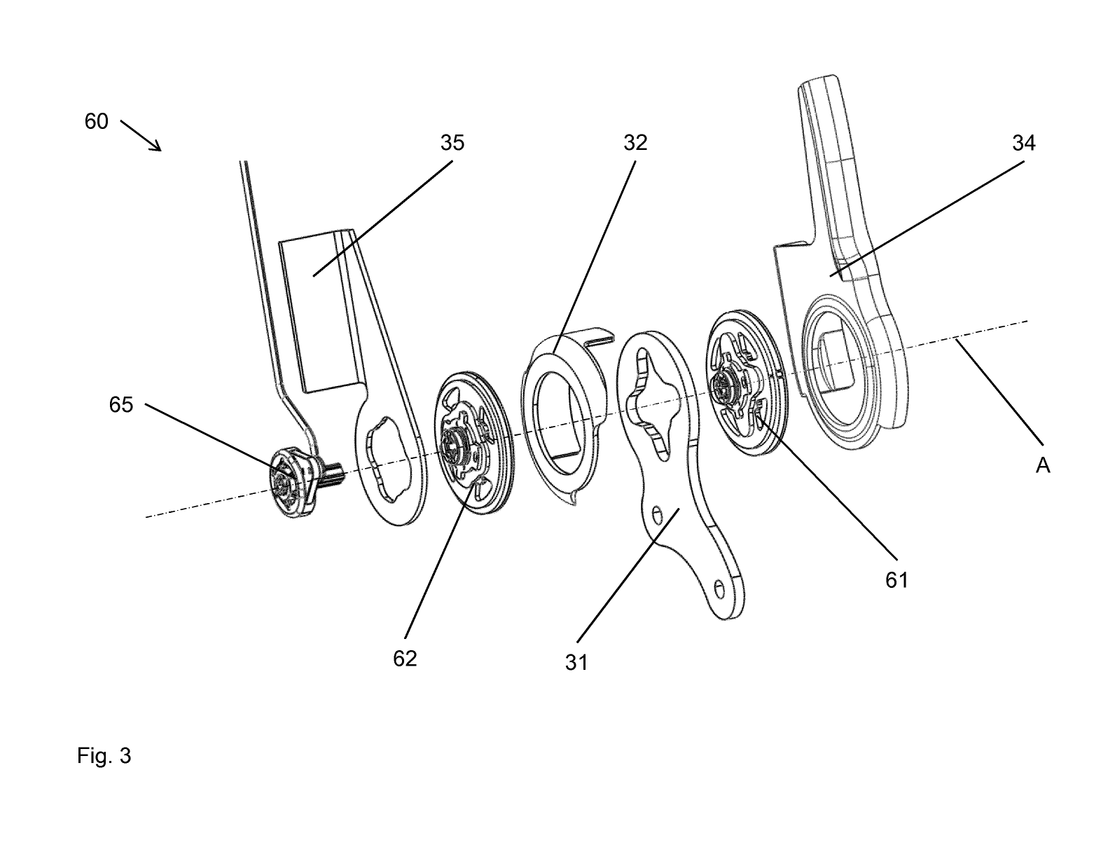

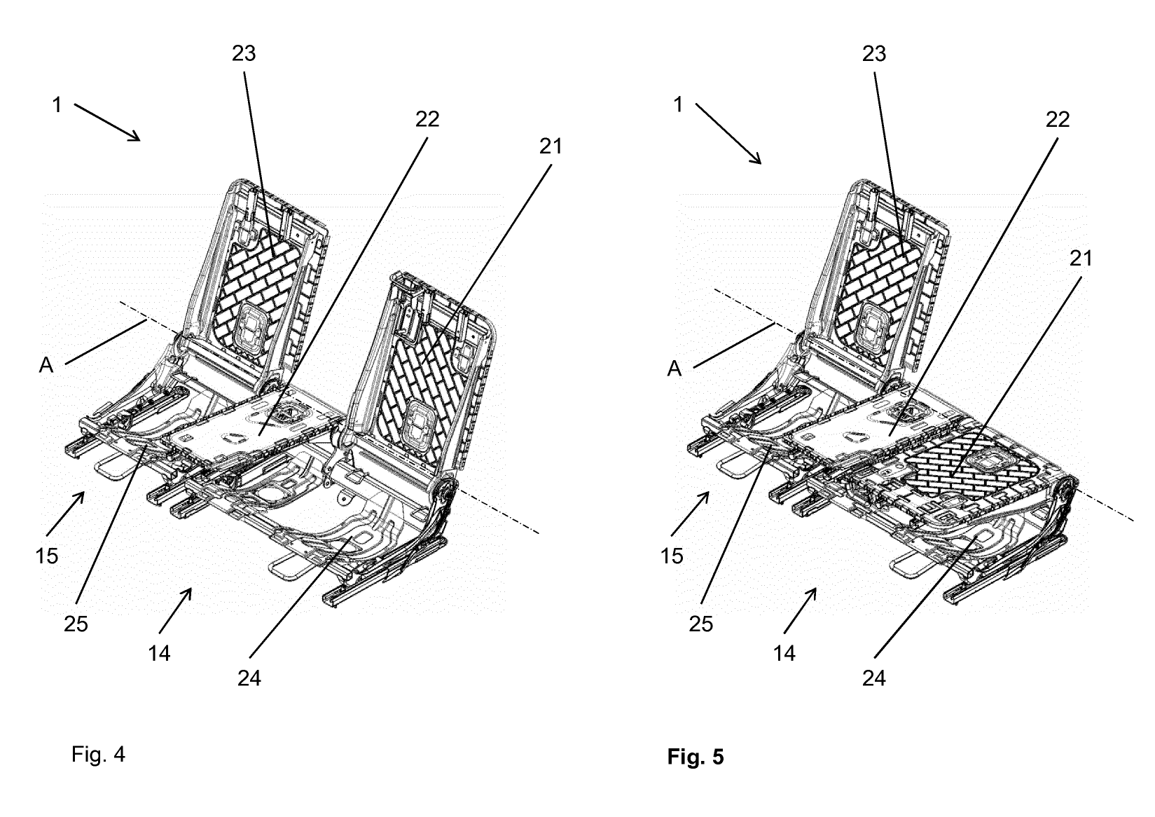

### DESCRIPTION OF THE PREFERRED EMBODIMENTS

Referring to the drawings, a vehicle seat 1 is constructed as a rear seat installation of a motor vehicle. The vehicle seat 1 comprises a first seat segment 14 having a first seat member 24 and a second seat segment 15 with a second seat member 25 which are connected independently of each other to the vehicle structure of the motor vehicle by means of a longitudinal adjuster so as to be longitudinally adjustable.

The arrangement of the vehicle seat 1 inside the vehicle and the conventional travel direction thereof define the directional indications used below. In this instance, a direction which is orientated perpendicularly relative to the ground is referred to below as the vertical direction and a direction perpendicular to the vertical direction and perpendicular to the travel direction is referred to below as the transverse direction. The vertical direction in this instance also includes angles of up to 30° with respect to the perpendicular and comprises in particular the orientation of a backrest of the vehicle seat 1 in an upright position for use, which backrest is mounted in the vehicle.

The first seat segment 14 is arranged at the left-hand side in the travel direction and takes up approximately 60% of the entire width of the vehicle seat 1. The second seat segment 15 is arranged at the right-hand side in the travel direction and takes up approximately 40% of the entire width of the vehicle seat 1. A first backrest 21 and a second backrest 22 are fitted to the first seat member 24 so as to be able to be pivoted about a pivot axis A, whilst a third backrest 23 is pivotably fitted to the second seat member 25.

The first backrest 21 is arranged at the left-hand side in the travel direction and the third backrest 23 is arranged at the right-hand side in the travel direction. The second backrest 22 is arranged in the transverse direction between the first backrest 21 and the third backrest 23. The pivot axis A extends horizontally in the transverse direction.

The first backrest 21 forms with a portion of the first seat member 24 a first seating position 11. The second backrest 22 forms with a portion of the first seat member 24 a second seating position 12. The third backrest 23 forms with the second seat member 25 a third seating position 13. The first seating position 11 and the second seating position 12 are associated with the first seat segment 14, the third seating position 13 is associated with the second seat segment 15.

The first seat member 24, the first backrest 21 and the second backrest 22 are provided with upholstery in a manner known per se. The second seat member 25 and the third backrest 23 are also provided with upholstery in a manner known per se. The first backrest 21 and the third backrest 23 take up approximately 40% of the entire width of the vehicle seat 1, whilst the second backrest 22 takes up approximately 20% of the entire width of the vehicle seat 1.

The first seat member 24 comprises a transverse cross-member 16 which extends in a transverse direction parallel with the pivot axis A and which extends approximately over the complete width of the first seat member 24.

The first backrest 21 is connected by means of an adjustment fitting 51, which is arranged at one side, in this instance at the left-hand side in the travel direction, to the transverse cross-member 16 of the first seat member 24.

The adjustment fitting 51 has a first fitting member which is securely connected to the transverse cross-member 16 of the first seat member 24, that is to say, secured to the seat member, and a second fitting member which is securely connected to the first backrest 21, that is to say, secured to the backrest, which can be pivoted relative to each other. In this instance, the two fitting members form in a structural sense a disc-like unit which is held together, for example, by means of a clamping ring.

In this instance, the adjustment fitting 51 is constructed as a catch fitting, that is to say, the two fitting members can be locked to each other by means of movable bars. The bars are moved, for example, by means of a resiliently loaded cam into a locking position. Such a fitting is, for example, disclosed in DE 10 2011 010 699 A1, the content of which is expressly incorporated herein by reference.

A fitting unit 60 is provided between the first backrest 21 and the second backrest 22. The fitting unit 60 comprises a first fitting 61 and a second fitting 62. In this instance, the fittings 61 and 62 are also, in the same manner as the adjustment fitting 51, constructed as catch fittings and each comprise a first and a second fitting member which can be pivoted relative to each other. The two fitting members of the fittings 61, 62 form in a structural sense a disc-like unit which is held together, for example, by means of a clamping ring.

The first fitting member of the first fitting 61 is securely connected to a first lower fitting member 31. The first lower fitting member 31 is secured to the transverse cross-member 16 of the first seat member 24.

The second fitting member of the first fitting 61 is securely connected to a first upper fitting member 34. The first upper fitting member 34 is secured to the first backrest 21.

The first fitting member of the second fitting 62 is securely connected to a second lower fitting member 32. The second lower fitting member 32 is secured to the first upper fitting member 34 and consequently also connected to the first backrest 21.

The second lower fitting member 32 and the first upper fitting member 34 are in this instance welded to each other. Other types of securing are also conceivable, in particular screwing or soldering.

The second fitting member of the second fitting 62 is securely connected to a second upper fitting member 35. The second upper fitting member 35 is secured to the second backrest 22.

The second backrest 22 is further connected to the transverse member 16 of the first seat member 24 by means of a rotary bearing 52, which is arranged at the side facing away from the fitting unit 60, in this instance at the right-hand side in the travel direction.

An unlocking unit 65 serves to unlock the second fitting 62. The unlocking unit 65 comprises an actuation button which is not illustrated and which is arranged in an upper region of the second backrest 22.

An actuation unit which is not illustrated and which is constructed in this instance as an unlocking lever serves to simultaneously unlock the adjustment fitting 51 and the first fitting 61. The actuation unit may, however, also be constructed, for example, as a loop, hand wheel or Bowden cable.

The unlocking lever is in this instance laterally fitted close to the adjustment fitting 51 to the first backrest 21 and connected by means of a transmission rod which is not illustrated to the adjustment fitting 51 and the first fitting 61.

By unlocking the adjustment fitting 51 and the first fitting 61 by means of the unlocking lever, the first backrest 21 can itself, on the one hand, be adjusted in terms of its inclination relative to the first seat member 24 into different positions for use and, on the other hand, be pivoted forward into a non-use position.

When the second fitting 62 is locked, the second backrest 22 is securely connected to the first backrest 21 and follows such a pivot movement of the first backrest 21.

By unlocking the second fitting 62 by means of the unlocking unit 65, the second backrest 22, when the first backrest 21 is located in a position for use, can be adjusted independently of the first backrest 21, on the one hand, in terms of its inclination relative to the first seat member 24 into different positions for use and, on the other hand, can be pivoted forward into a non-use position.

The fitting unit 60 is constructed in such a manner that the backrests 21, 22 are connected for entrainment in a pivot direction and there is a free running action in the other pivot direction.

If, when both backrests 21, 22 are in a position for use, after unlocking the second fitting 62, the second backrest 22 is pivoted forward and downward into the non-use position, there is a free running action with respect to the first backrest 21, which may remain in the upright position for use.

If, when both backrests 21, 22 are located in the non-use position, after unlocking the second fitting 62, the second backrest 22 is pivoted backward and upward into a position for use, there is an entrainment connection with respect to the first backrest 21 which is consequently also pivoted into the upright position for use, as long as the first fitting 61 and the adjustment fitting 51 are also unlocked. The basic principle of such a free running action may be constructed as disclosed in DE 10 2013 003 790 B3.

The features disclosed in the above description, claims and drawings may be significant both individually and in combination to implement the invention in its various embodiments.

While specific embodiments of the invention have been shown and described in detail to illustrate the application of the principles of the invention, it will be understood that the invention may be embodied otherwise without departing from such principles.

1. A vehicle seat having a seat segment comprising:
a first seating position having a first backrest and
a second seating position having a second backrest and
a seat member, wherein the first backrest and the second backrest are connected to the seat member and can be pivoted relative to the seat member about a pivot axis
a first fitting comprising a first fitting first fitting member connected to the seat member in a rotationally secure manner and a first fitting second fitting member connected to the first backrest in a rotationally secure
a second fitting comprising a second fitting first fitting member connected to the first backrest in a rotationally secure manner and a second fitting second fitting member connected to the second backrest in a rotationally secure manner, the first fitting and the second fitting being arranged in a region of the pivot axis.

2. The vehicle seat as claimed in claim 1, further comprising an unlocking unit by means of which the second fitting can be unlocked independently of the first fitting.

3. The vehicle seat as claimed in claim 1, wherein the second backrest is additionally connected to the seat member by means of a rotary bearing.

4. The vehicle seat as claimed in claim 1, further comprising an adjustment fitting comprising an adjustment first fitting member connected to the seat member in a rotationally secure manner and an adjustment second fitting member connected to the first backrest in a rotationally secure manner.

5. The vehicle seat as claimed in claim 4, further comprising an actuation unit by means of which the adjustment fitting can be unlocked at the same time as the first fitting.

6. The vehicle seat as claimed in claim 1, wherein there is, when pivoting the second backrest from a position for use into a non-use position, a free running action with respect to the first backrest.

7. The vehicle seat as claimed in claim 1, wherein there is, when pivoting the second backrest from a non-use position into a position for use, an entrainment connection with respect to the first backrest.

8. The vehicle seat as claimed in claim 1, further comprising a first lower fitting member, wherein the first fitting first fitting member is securely connected to the first lower fitting member which is spatially arranged between the first fitting and the second fitting.

9. The vehicle seat as claimed in claim 8, further comprising a second lower fitting member, wherein the second fitting first fitting member is securely connected to the second lower fitting member which is arranged spatially between the first fitting and the second fitting.

10. The vehicle seat as claimed in claim 9, further comprising a first upper fitting member, wherein the first fitting second fitting member is securely connected to the first upper fitting member which is securely connected to the second lower fitting member.

11. The vehicle seat as claimed in claim 9, wherein the second lower fitting member partially engages around the first lower fitting member radially at the outer side.

12. The vehicle seat as claimed in claim 1, wherein a fitting unit is provided between the first backrest and the second backrest and the fitting unit comprises the first fitting and the second fitting.

13. The vehicle seat as claimed in claim 12, wherein the fitting unit is arranged in the region of the pivot axis.

14. The vehicle seat as claimed in claim 1, wherein the first fitting and the second fittings each form a structural disc.

15. The vehicle seat as claimed in claim 14, wherein the two fitting members of each of the first fitting and the second fitting are each held together by a clamping ring.
